(19) United States
(12) Patent Application Publication
(10) Pub. No.: US 2022/0129805 A1
(43) Pub. Date: Apr. 28, 2022

(54) DIGITAL PLATFORM FOR AUTOMATED ASSESSING AND RATING OF CONSTRUCTION AND ERECTION RISKS, AND METHOD THEREOF

(71) Applicant: Swiss Reinsurance Company Ltd., Zurich (CH)

(72) Inventors: Stephan RUCKABERLE, Jonen (CH); Anne LOHBECK, Schindellegi (CH)

(73) Assignee: Swiss Reinsurance Company Ltd., Zurich (CH)

(21) Appl. No.: 17/472,117

(22) Filed: Sep. 10, 2021

Related U.S. Application Data
(63) Continuation of application No. PCT/EP2020/079997, filed on Oct. 26, 2020.

(51) Int. Cl. G06Q 10/06; G06Q 40/06; G06Q 50/08; G06N 3/02

(52) U.S. Cl. CPC G06Q 10/0635; G06Q 10/06393; G06N 3/02; G06Q 50/08; G06Q 40/06

(57) ABSTRACT

A digital platform for automated prediction and quantified measuring of exposure-measures measuring occurring construction and erection risks of an engineering or construction project and for automated forecast and measuring of future occurring loss patterns induced by occurring construction/erection risk events to the project measurably exposed to construction/erection risks. An engineering risk profile of a project associated with and exposed to construction and/or erection risks is assembled, and, based on the predicted and measured future occurring losses patterns, risk-tailored expert advices for underwriting parameters are provided.

### CROSS REFERENCE TO RELATED APPLICATION

The present application is a continuation application of International Patent Application No. PCT/EP2020/079997, filed on Oct. 26, 2020, the content of which is hereby incorporated by reference in its entirety.

### FIELD OF THE INVENTION

The present invention relates to automated systems for measuring of and/or forecasting future occurrence probabilities and event risks, respectively, and for quantized assessment of probably associated event impacts and probabilities of losses occurring. In particular, the invention relates to automated systems and methods for risk measurement and assessment in the context of construction and engineering risks and risk accumulations associated with construction and engineering risks. More particularly, it relates to forecasting and exposure-based signaling, steering and/or operating of constructional or engineering risk-event driven or triggered systems, in general, but even more particularly systems for automation of underwriting, risk management, risk portfolio steering and signaling involving an improved identification of constructional or engineering risks, i.e. measured occurrences of construction or engineering risk events showing loss impacts, and forecast or prediction of their quantified impacts, and/or an improved ability to initiate or trigger appropriate risk mitigation measures to cope with the occurring construction or engineering risks, and/or an improved user-scenario-based modeling quantifying constructional or engineering risk exposures, and/or improved resource/risk balancing with improved risk charge/costing signaling and optimized loss-ratio handling.

In general, it relates to automated measuring and signaling systems and methods for measuring or assessing risk measure in the context of construction and engineering risk occurrences and accumulation. The present invention can be used for signaling and steering of automated underwriting, risk management, portfolio steering, client management devices. The present invention can be used for automated precise identification of liability catastrophes and to improve prediction/forecasting of associated impacts of such construction or engineering risk events, based on actual measurement and predictive modeling of parameters. One of the core functions of such systems is to provide a quantifiable and reproducibly measurable measure for the probability of occurrence, i.e. the risk, of future liability losses arising from scenarios where multiple risk-transfers are involved possibly in multiple locations over longer periods of time. The present invention is particularly directed to automated risk-transfer and underwriting systems and instruments intended to hedge against such constructional or engineering risks, i.e. the probability of a future measuring/occurrence of an impacting constructional or engineering risk event.

### BACKGROUND OF THE INVENTION

The machine-based prediction and assessing of occurrence probabilities for construction and engineering risk events causing loss impacts to construction and engineering projects are technically difficult to achieve because of their complexity and often long-tail nature and their susceptibility to a broad range of measuring parameters and parametrizing quantities, in particular their difficult-to-capture temporal time development and parameter fluctuation of the various components of a construction or engineering project. Thus, for single risks in the construction area the measuring and prediction of the expected loss is technically complex and driven by manifold underlying factors about the risk and its geographical and technical ecosystem. However, for construction or engineering projects, in particular large projects, the user need to understand what the associated risk measures and rates for such risk exposures, and what the key drivers for the rates are. Typically the users lack the broad expertise and a record of historical rates and events. Furthermore, users usually don't have access to broader risk portfolios to easily reapply certain risk parameters for similar risks. Acknowledging this, the lacking technical ability to standardized benchmark processing certain risk categories or industries gets visible.

Further financial and other impacts associated with defects in construction or engineering projects has been rising in recent years. As the number of construction-related claims submitted continue to increase, builders and their insurance companies find themselves exposed to ever greater financial risk. To some extent, a constructor's characteristic business practices and construction quality practices can be used to predict the likelihood that the constructor will become involved in construction-related claims or litigation. Identifying a constructor's predicted level of risk could be valuable to a variety of parties, among them insurance companies who are considering insuring the builder. However, there is no easy way to distinguish between high-risk constructors and low-risk constructors because no standardized measure exists in the building industry to express a level of risk involved in insuring a constructor. Further, many construction or engineering projects consist of a plurality of different components exposed to different risks and risk-structures, and in addition are constructed or engineered by different constructors having their individual risk exposure. In the face of this uncertainty, there is a demand for an automated standardized measurement and risk-assessment tool, allowing an unified access to monitoring and reporting of constructional and engineering risks.

Automated systems for precise, reliable and reproducible risk measurement, prediction, mitigation and assessment are fundamental in today's operative environment for industries in all parts of technology, construction and engineering. This is because there is always risk exposure for any industry, the exposure typically occurring in a great variety of aspects, each having their own specific characteristics and complex behavior. The occurrence of constructional or engineering risk events with associated loss impact can be fatal to a whole sector of industry, if the risk was not correctly anticipated and appropriately mitigated. However, risk measurement and assessment is technically complicated, and appropriate modeling structures often not sufficiently understood to allow a technical and/or instrumental approach. In particular, the complexity of the behavior of risk exposure-driven technical processes often has its background in the interaction with chaotic processes occurring in nature or artificial environments. Good examples can be found in weather forecasting, earthquake and hurricane forecasting or controlling of biological processes such as related to heart diseases, controlling of financial market-triggered systems or the like. Monitoring, controlling and steering of technical devices or processes interacting with such risk exposure is one of the main challenges of engineering in industry in the 21st century. Risk-dependent or triggered systems or processes such as automated underwriting, risk management, risk portfolio steering and pricing tools or forecast systems are all connected to the above technical problems and challenges. Pricing risk-triggered vehicles, such as automated risk transfer or insurance products, is additionally difficult because the pricing must be done before the product is sold but must reflect future impacts, losses and occurrences of events, which can never be assessed or measured with complete accuracy. With tangible products, for example, the cost of goods sold is known beforehand, since the product is developed from raw materials which were acquired before the product was developed. With risk-triggered products, this is not the case. The coverage of the probably occurring event impact must be set/assessed in advance. If the actual occurrence (not the forecasted occurrence) of risk events and associated losses is greater than the cover or risk mitigation measures, e.g. the amount of transferred resources, typically premiums collected, then the risk transfer or insurance system's operability will be corrupted. A precise, reliable, forward-looking and reproducible risk measurement, prediction and assessment is therefore vital to all risk-triggered systems and processes. Hence, the ability to forecast and set assumptions for the expected losses is critical to the operation. The present invention was developed to optimize triggering, identifying, assessing, forward-looking modeling and measuring of CAR/EAR risk-driven exposures and to give the technical basics to provide a fully automated pricing device for CAR/EAR exposure comprising self-adapting and self-optimizing means based upon varying CAR/EAR risk drivers.

### SUMMARY OF THE INVENTION

It is an object of the invention to provide a construction and/or engineering risk-driven system for automated predicting, assessing and rating construction and erection risks (CAR/EAR). In particular, it is an object of the present invention to provide a system which is better able to capture the external and/or internal factors that affect construction and erection risk exposures, while keeping the used trigger techniques transparent. Moreover, the system should be better able to capture how and where risk is transferred, which will create a more efficient and correct use of risk and loss drivers in CAR/EAR insurance technology systems. Furthermore, it is an object of the invention to provide an adaptive underwriting and pricing tool for risk-transfers based upon CAR/EAR exposure. However, the system should not be limited by the size, complexity or geographic range of risks, but should be easily applied also to small-, medium- or large-size risks. It is an object of the invention to develop automatable, alternative approaches for the recognition and evaluation of CAR/EAR exposure. These approaches differ from traditional ones in that they rely on underwriting experts to hypothesize the most important characteristics and key factors from the operating environment that impact CAR/EAR exposure. The system should be self-adapting and refining over time by utilizing data or parameter measuring inputs as granular temporal data available in specific markets or from risk-transfer technology databases. The measured/generated events and triggered data should be mainly quantified using technological measurements.

According to the present invention, these objects are achieved particularly through the features of the independent claims. In addition, further advantageous embodiments follow from the dependent claims and the description.

According to the present invention, the abovementioned objects are particularly achieved by the inventive, digital platform for automated predicting and quantified rating of exposure measures associated with occurring construction and erection risks (CAR/EAR: Contractors All Risks Risk-Transfer/Erection All Risks Risk-Transfer) of an engineering or construction project and for automated prediction and measuring of future occurring loss patterns induced by the occurring construction/erection risks to the project exposed to said construction/erection risks, wherein an engineering risk profile of a project associated with and exposed to construction and/or erection risks (CAR/EAR) is assembled, and wherein, based on the predicted and measured future occurring losses patterns, risk-tailored expert advices for underwriting parameters are provided, in that a predictive system of the digital platform comprises a persistent storage which includes at least a data-structure for capturing technical parameters, and user- and market-specific working parameters, in that the technical parameters comprise (i) objective risk parameters for at least capturing geo location parameters and/or type of industry parameters and/or type of project parameters and/or structure of the project parameters and/or duration parameters and/or involved values at risk parameters, and further comprise (ii) cover component parameters at least comprising cover type parameters and/or deductibles parameters and/or sublimit parameters, in that a generic framework structure is maintained based on the working parameters for capturing user-specific pricing logics, the working parameters comprising (i) first working parameters quantifying individual risk measures, and (ii) second working parameters quantifying user-specific internal and external cost measures, in that the generic framework structure comprises a first trigger stage identifying and capturing objective cost measures triggered by the objective risk parameter values and the cover component parameter values, and a second trigger stage capturing market-specific prize measures triggered by the first and second working parameter values providing the user-specific price logic, wherein the generic framework structure comprises (a) an assessable by a user interface for receiving user-defined values for one or more objective or working parameters relating to the project, (b) a weighting module for adjusting the technical cost measures based on the first working parameters quantifying the individual risk measures, and (c) an aggregation module aggregating the technical cost measures with the second working parameters quantifying the user-specific internal and external cost measures, and in that the digital platform comprises an advice engine generating user-specific expert advices to the user for optimizing the user-specific cover component parameters by referring to underlying policy wording and clauses, wherein optimized user-specific cover component parameter values and corresponding prizing parameter values are provided associated with the generated user-specific expert advices, and wherein, by means of the user interface of the digital platform, the underwriting parameters and associated rates, respectively, are dynamically adjustable by a user.

The digital platform can e.g. comprise a user interface for receiving user-defined values for one or more technical or working parameters associated with the project, wherein each project has a risk profile with a project-specific parameter set assigned, wherein for the assigned risk profile each type of project consists of a ratable standard set of types of objects and wherein based on the received user-defined values, relevant types of objects for the project are automatically selected by the system by adding or deleting types of objects from the standard set. The selecting the objects for the project by means of the received user-defined values can e.g. comprise defining the scope of the project to be quoted including a dataset describing the selected project and/or objects and the related technical characteristics as technical parameters. A rating process, as a result of applying a set of rules, can e.g. be processed to generate a rating analysis by the expert system, and to output one or more of underwriting hints for the risk-covered project, the rating analysis includes the following: a deductible associated with one or more covered risks, and a premium associated with one or more covered risks. The process of applying the set of rules can e.g. comprise: (i) applying one or more triggers to test for values of one or more data items that represent risk-related values by making a true or false determination with respect to a value of the values; (ii) activating a rule based structure on a test result of one or more of the triggers to generate the one or more underwriting hints to be outputted, wherein the underwriting hints are separate from the deductible and the premium and include at least the following: (a) identification of a risk associated with a geographical area for the risk-covered project, (b) hints to minimize exposure for a peril which include at least one hint which recommends requesting construction to resist damage from a particular type of peril, and (c) identification of a risk associated with one or more technical characteristics of the risk-covered project; (iii) providing the rating analysis and the outputted underwriting hints to a monitoring interface; and (iv) applying one or more additional triggers to test for values of data parameters outputted from the rating analysis. The processing of the rating process can e.g. be performed at the object level by requiring a distinct selection of objects from the technical parameters using a defined standard subset of types of objects from the technical parameters associated with each type of project, wherein, if only a type of project is selected by the user, a standard subset of type of objects from the technical parameters are selectable to run the rating process. The processing of the rating process can further e.g. comprise passing values for characteristics that are valid for the entire project and which are entered at the project level to underlying objects at the object level, and directly entering values for technical and risk-transfer related characteristics that are only valid for specific objects at the object level.

Further, regarding the captured parameter values and/or data stored in the digital platform, the system-related core data can at least comprise software application data at least comprising messages, prompts, user preferences, application settings and logging/tracing information. Technical parameters can e.g. at least comprise data types of industries, data types of projects, data types of objects, a standard subset of types of objects for a type of project, data types of periods, classes of data types of objects, data types of perils of nature, data types of covers of extension, data types of rate tables, data types of tariff algorithms, default parameters, business validation rules, data validation rules, and domains of all data types. The working parameters can e.g. comprise user generatable data restricted to read, write and modify access by the user only. Finally, the captured risk-related technical parameter values can e.g. comprise at least a technical characteristic, an insurance related characteristic, a type of project, and a type of object. The optimized user-specific cover component parameter values and corresponding prizing parameter values can e.g. be generated by means of a rating process, wherein the rating process includes determining premium parameter values and deductible amounts parameter values. The optimized user-specific cover component parameter values and corresponding prizing parameter values can at least comprise parameter values related to an risk-transfer covering of the risk-exposed project. The capturing of the technical parameters can e.g. at least comprise parameter values for selecting a type of industry associated with the risk-exposed project. Finally, the user-specific expert advices can e.g. comprise parameters values providing underwriting hints, which indicate severity of a risk associated with the project.

The invention has, inter alia, the advantages that digital systems is able to provide IDI risk-transfer (Inherent Defects Insurance, Decennial cover). The digital platform allows to provide automated analyzing and predicting/calculating project/property related IDI covers, i.e. risk-transfers. Further, it allows, as technical mandatory boundary conditions, to consider regulation specific parameters for the underwriting/quoting as well as object related risk parameters. A final risk-transfer quote for IDI is supported by (a) identifying the technical cost parameters according to the objective risk parameters like geo location, involved values at risk, as well as all relevant cover components (deductibles, limits), and (b) defining the market-specific prize according to pricing-relevant factors, and cost loads for internal and external cost. The digital platform allows to consistently measure, assess and rate construction and erection risks (CAR/EAR). In addition, it allows providing an automated underwriting base for maximum range of complexity in engineering risks. The digital platform also enables consistent, systematic handling of quotations, and related documentation by technical means. Finally, the digital platform allows providing recommendation on exposure and risk management. The digital platform according to the invention allows to provide an automated expert underwriter on users side with a solid, proven and trusted measuring/prediction/calculation engine of the expected loss measures of construction/erection risks, for any kind of risk complexity. The digital platform allows to provide the expected loss measures in a guided way build into a standardized technical assessment approach, and provides automated, risk-tailored UW advice as well as the opportunity to dynamically adjust the rates according to experience and loss patterns. For users with large portfolios of risk-exposed construction or engineering projects, the digital platform is the same time a technical way to monitor entire engineering portfolios based on a standardized technical assessment approach. In summary, the invention has inter alia the advantages to provide a novel construction and/or engineering risk-driven system for automated predicting, assessing and rating construction and erection risks (CAR/EAR). In particular, it provides a novel system which with technically improved infrastructure and technical means to capture the external and/or internal factors that affect construction and erection risk exposures, while keeping the used trigger techniques transparent. Moreover, the system, by its novel technical structure, has an improved capability to detect and capture how and where risk is transferred, which will create a technically more efficient and correct use of risk and loss drivers in automated CAR/EAR risk-transfer technology systems. Furthermore, it the invention has an improved to provide a dynamically adaptive, measuring parameter-values-based underwriting and pricing tool with dynamically adapting monetary parameter value for risk-transfers based upon CAR/EAR exposure. However, the automated system should is not limited by the technically measurable size, complexity or geographic range of risks, but its technical structure can be easily applied to small-, medium- or large-size risks and occurring physical events having a physical impact to exposed units. Finally, the invention has the advantage that it provides a novel, automatable, alternative approach for the recognition, measurement and evaluation of CAR/EAR exposure. These approaches differ from traditional ones in that it rely not on human underwriting experts to hypothesize the most important characteristics and key factors from the operating environment that impact CAR/EAR exposure, i.e. the measurable occurrence of defined events with impact on the exposed units. The automated system provides a novel structure capable of self-adapting and refining over time by utilizing data or parameter measuring inputs as granular temporal data, i.e. available in specific, defined technology sector segments or markets or from risk-transfer technology databases. The measured/generated events and triggered data are used in a novel way being mainly quantified using physical, technological measurements and measuring data. It is to be noted that the invention started by generally automated systems for measuring of and/or forecasting future occurrence probabilities and event risks, respectively, and for quantized assessment of probably associated event impacts and probabilities of losses occurring. However, due the technical requirements by the automation process, the technical skilled man restricted the automation of the system by specifically selecting construction and erection risks, which are inherently associated with technical structures providing the possibility of direct measuring of the occurrence frequency of technically measurably physical events, e.g. having a physical impact to the technical structures concerned i.e. measurable in loco by physical measuring devices and measuring sensors. Though, each measurement depends on the specific component of the construction, the fact has to be stressed that it is technically specific for physical construction and erection damage and associated risks (i.e. the measured forecasted future probability of an occurrence) that construction and erection damage and associated risks typically can be physically measured by appropriate sensors and measuring devices. Just to give a concrete example: For monitoring the construction of post-tensioned concrete and detecting damage to the concrete under loading conditions, embedded sensors can be used that measure pre-stress from the fabrication process to a failure condition. In this example, e.g. four types of sensors can be installed on a steel frame, while the applicability and the accuracy of these sensors typically are tested and calibrated while pre-stress is applied to a tendon in the steel frame. As a result, e.g. a tri-sensor loading plate and a Fiber Bragg Grating (FBG) sensor can be selected as possible candidates. With those sensors, two pre-stressed concrete flexural structure is fabricated and tested. The pre-stress of the tendons is measured and monitored during the construction and loading processes. Through the test, it can be ascertained that the measured variation in the pre-stress is successfully monitored throughout the construction process. The losses of pre-stress that e.g. occurs during a jacking and storage process, even those which occur inside the concrete, can so be measured successfully. For example, there are also further results as e.g. the such results of the loading test how that measured tendon stress and strain within the pure span increases, while the stress in areas near the anchors typically stay almost constant. Thus, such FBG sensors installed in a middle section can be used as an example how to technically measure and monitor constructional occurrences of physical damages, here the strain within, and the damage to pre-stressed concrete. However this is just an example. In general, different sensor technics can be used to measure different types of constructional damages an associated constrational risks, in particular also smart sensing, monitoring, and damage detection for infrastructures. Smart sensors technology for constructional environments include optical fiber sensors, piezoelectric sensors, and wireless sensors. The applicable structural monitoring/damage detection techniques also comprise techniques such as ambient vibration-based bridge health measurements, piezoelectric sensors-based local damage detection, wireless sensor networks and energy harvesting, and wireless power transmission by laser/opto-electronic devices. The required measuring techniques may vary already on the use of the construction, as e.g. road bridges, cable-stayed bridges, and railroad bridges. To stay with the bridges as other technical example, the measurements can e.g. be conducted using optical fiber system embedded into the structural elements. This allows measuring, monitoring and controlling the structural efficiency during the phases of construction, and allows the periodical check of the structural performance under service loads. Sensors are in this case directly anchored to the prestressing strands during the manufacturing phases of the precast beams. By processing and analyzing the data acquired by the system during the different construction phases, it is possible to assess the strain variations related to load increments and stress losses, by comparing them with expected simulated values. Thus, a real-time monitoring procedures is provided which is a precious instrument for checking the structural safety of critical facilities, in particular bridges.

The key features and core advantages of the digital platform comprise: (a) The digital platform allows to rate all kind of risk complexity: basically, all kind of engineering risk profile can be rated with the digital platform. No matter what complexity the risk, which is going to be built in a defined project duration, is carrying; (b) The digital platform can be applied to all-risk covers: The digital platform allows to calculate all-risk covers in construction (CAR) and erection (EAR) for hugely divers projects (e.g. building of dams, all kind of power plants, mining sites, airports, motorways, hospitals, etc.); (c) The digital platform provides automated UW advice: The digital platform provides, based on its engineering wording, advices to include and consider specific clauses. With this advice, a underwriter gets support to better assess the nature of the risk and provide clear terms for the offer. This helps top manage the covered risk and technically entire engineering portfolios appropriately in this very dynamic field of risk-transfer covers; (d) The digital platform allows providing a global reach: The digital platform has no geo-limitation for risk assessments and can comprise associated and technically linked, automated catastrophe risks measuring or prediction systems; (e) The inventive digital platform allows providing measures at a new technical level of accuracy: Final rates for a risk are considering influencing factors (soft factors), aside to the hard factors tied to the real risk profile. The hard factors are resulting in the expected loss, which is one of the main measures provided by the digital platform. This lead rate measure needs absolute accuracy to exactly determine appropriate cost parameters, no matter how this rate is being adjusted in the pricing process e.g. according to existing underwriting guidelines of a company; and (f) The digital platform allows providing automated cover extensions: Aside to the very core elements in CAR/EAR, the digital platform allows providing inclusion of cover extensions in addition to the base cover of Material Damage (MD) in CAR/EAR. Possible cover extensions can e.g. include: TPL (Third-Party-Liability), Natural Perils (Earthquake, Flood, and Storm), DSU (Delay-in-Start-Up), ALOP (Advance Loss of Profit), and/or CPE (Contractors Plant & Equipment) etc.

As an embodiment variant the monitoring and reporting interface of the digital platform comprises a portfolio management interface for analyzing and monitoring a portfolio of construction/erection risks exposed projects, wherein a plurality of construction/erection risks exposed projects are gathered by means of one portfolio data structure. The monitoring of the portfolio can e.g. comprise extracting key performance indicator measures associated with the portfolio at least comprising monitoring and/or reporting of accumulation parameters and/or costing/pricing parameters and/or country-specific parameters and/or developments indicators and/or rate developments indicators and/or portfolio sanity indicators. This embodiment variant has further the advantage that it provides the technical basis for automated portfolio management functionality in place to monitor and overview all IDI covers calculated by an external party.

As another embodiment variant, the advice engine can e.g. comprise a machine-based intelligence comprising a machine-learning based structure or a neural-network-based structure generating the user-specific expert advices, wherein the machine-based intelligence in a learning mode assesses optimized underlying policy wording and clauses of historical projects together with optimized user-specific cover component parameter values and corresponding prizing parameter values, and wherein in a processing mode, the machine-based intelligence provides the user-specific expert advices to the advice engine. This has, inter alia, the advantage, that the inventive digital platform allows providing a new technical level of automation.

Traditional automation of risk assessment approaches technically typically focus on correlations between loss and exposure data. These systems are not able to capture risk accumulation or complex construction and/or engineering risk issues in a portfolio of accomplished risk transfers. Likewise, these systems are not sufficiently able to incorporate loss generating mechanisms and loss drivers, which are essential when entering new environmental or other boundary conditions, such as markets, or when environmental or boundary conditions change. The technical structure of the present invention is capable of expanding its approach beyond traditional rating methods for automated systems by being able to apply capturings and measurements from behavioral economics, and risk and catastrophe modelling approaches. This has inter alia the further advantage of allowing for a more accurate pricing of risks, i.e. of better weighting and calibrating the balancing of accumulated risks (i.e. risk portfolio) with the accumulated resources to provide risk bearing entities with coverage or protection and ensuring a stable operation of the risk accumulating unit by balanced and well-adjusted loss ratio parameters. The loss ratio parameters typically provide the ratio of total losses incurred (paid and reserved) in claimed losses plus adjustment expenses divided by the total resources (e.g. premiums) accumulated. Balance point or balance measure for loss ratio parameters for construction and engineering risk-transfer have a limited range for traditional systems. Such risk-transfer entities are collecting resources more than the amount to be transferred in covering loss claims. Conversely, risk transfer systems or entities that consistently show a high loss ratio measure will automatically corrupt their long-term operation. Accurate prediction of the loss ratio measures for a future time interval is essential in optimizing underwriting and the automation of the operation of such a system. The most optimized operative parameters for such an automated system are typically called the target measures. Technically, the loss ratio parameter is normally provided 1 minus the operative expense ratio, where the expenses consist of all expenditures necessary to allow the operation of the risk-transfer system. Expenses associated with risk-transfer coverage (“losses”) are considered part of the loss ratio. To generate a control rate change, the risk-transfer system may measure the incurred or actual experienced loss ratio (AER) by the permissible loss ratio, necessary in order to uphold, i.e. not corrupt, the automated operation of the system, which is to ensure the long-term stability of the automation. Thus, for automated underwriting systems, the performance can be monitored, as discussed above.

The present invention has further the advantage of allowing for a most accurate prediction of future outcomes, for example, the characteristics of measured future losses, by reflecting the mechanics and processes that drive them by the technical structure of the invention. Thus, the operation of the present invention goes beyond a mere rollforward of past experience and has the built-in flexibility to evolve and to take into account current and future changes. The structure allows validation and training through an understanding of historical experience, which forms a subset of what the system's modelling can predict. This has also the advantage that it technically allows the system's prediction to be applied in situations with and without relevant historical experience, which is not possible by the known prior art systems. The prediction structure of the digital platform also go beyond traditional prediction and forecast systems' approach by implementing a structured cause-effect chain. The obtained results from the predictions can thus be transferred from data-rich contexts into the future and to other contexts where experience and data is sparse, for instance in complex parameter fields such as high growth markets. The present invention makes it possible to predict future outcomes of risk-transfer risks precisely in changing economic, societal, technological, and legal conditions, and thus provide a preferable technical approach to accurately predicting liability risk parameters and measures. The input parameters of the prediction structure are known as risk drivers, and typically are measured directly during operation of the present invention. They are parameterized from sources other than ultimate monetary past loss amounts. Such sources include validated insights of risk-exposed affected units and loss claims adjusters as well as macro-economic data and other external data sources. This construction makes it possible to focus the prediction of the automated digital platform on relevant loss data rather than being obliged to arbitrarily utilize any available loss data. Since the implemented prediction structure of the present invention explicitly reflects also complex structured cause-effect chain based on many different components of a project, it can be developed in a modular way which in turn allows extensions by adapting only the corresponding module instead of having to start from scratch.

Concerning the term construction and engineering all risks (CAR/EAR) and risk accumulation, it is to hold that for the present invention, construction and engineering risks can involve multiple risk-exposed affected components of a project potentially over a long time and over many places. They therefore lead to risk accumulation, and the exposure to them is complex and needs to be treated carefully. The present inventive risk-assessment and prediction platform can be used for several purposes by measurably quantifying the constructional or engineering risk losses arising from scenarios where more than one causing company is involved, and/or a causing company is involved in more than one role. It allows entities to transfer risks from a deep understanding of the occurring risk events and their possible impacts on the economics and risks in them, but also to steer portfolios automatedly, monitor market conditions, automatically set reserves, support regulatory and investor-related automated reporting and monitoring mechanism. At a market level, the inventive approach to automated CAR/EAR prediction supports rational and sustainable pricing and risk-taking. At an entity/company level, it provides a competitive advantage by a more stable and accurate operation allowing a more efficient and optimized resource allocation.

### BRIEF DESCRIPTION OF THE DRAWINGS

The present invention will be explained in more detail below relying on examples and with reference to these drawings in which:

FIG. 1 shows a block diagram, schematically illustrating the inventive digital platform 1 for automated assessing, predicting and rating construction and erection risks (CAR/EAR). The digital platform 1 provides automated prediction and quantified rating of exposure measures associated with occurring construction and erection risks 31 induced by construction and erection risk events 33 of an engineering or construction project 20-26 and for automated prediction and measuring of future occurring loss patterns 1511, . . . , 151i induced by the occurring construction/erection risk events 33 to the project 20-26 exposed to said construction/erection risks 31. An engineering risk profile 101i2 of a project 20-26 associated with and exposed to construction and/or erection risks 31/CAR/EAR is assembled. Based on the predicted and measured future occurring losses patterns 1511, . . . , 151i, risk-tailored expert advices for underwriting parameters are provided.

FIG. 2 shows a flow diagram schematically illustrating an exemplary process conducted by the inventive digital platform 1 for automated assessing, predicting and rating construction and erection risks (CAR/EAR).

FIG. 3 shows a simplified flow diagram schematically illustrating an exemplary process conducted by the inventive digital platform 1 for automated assessing, predicting and rating construction and erection risks.

FIGS. 4a-b, 5a-f, 6a-c, 7a-d, 8a-b, 9a-b, and 10 show graphical diagrams schematically illustrating exemplary user interfaces of the inventive digital platform 1 for automated assessing, predicting and rating construction and erection risks. The standardized user interfaces allows the digital project underwriting management platform to provide automated support for engineering underwriters, as well as other users, in an elaborate process to accurately predict and assess risks of large construction projects. The digital platform 1 allows projects to be set up fast, quickly providing the underwriter with a first automated assessment of the price parameters, by accessing the data of similar projects. As FIGS. 6a-c show, underwriters can choose to create an empty project, use a template related to the basic project parameters, or import the setup from another existing project. Through reflecting of the users' workflow by the technical structure of the platform 1, the digital platform 1 is able to combine four of the screens (see FIGS. 7a-d), that are at the heart of the inventive risk prediction and estimation process, into one interactive monitoring screen (see FIG. 1) —improving efficiency, flexibility and clarity in comparison to state of the art systems. The platform 1 provides full transparency and flexible guidance. Key results are generated by the digital platform in real-time and are displayed at any time in the process, reducing a lot of back and forth. The digital platform 1 provides a clear separation between project description and risk-transfer cover. This way underwriters can switch between these two very different tasks, while instantly seeing the impact of changes on the price parameter generations by the digital system 1. For the covers, the digital platform 1 comprises an interaction structure that allows the users to either access the different risk-transfer covers individually or go through all of them in a structured, wizard-like and well-guided process reducing the risk for errors and giving the users substantial control. FIGS. 8a-b show an generated overview of all covers, while FIGS. 9a-b show a graphical user interface monitoring cover details. FIG. 10 illustrates the process form the dashboard to stand alone application. The digital platform 1 enables the user to quickly recognize the application he is working on and easily switch between different projects and applications when working in the browser with multiple open tabs.

### DETAILED DESCRIPTION OF THE PREFERRED EMBODIMENTS

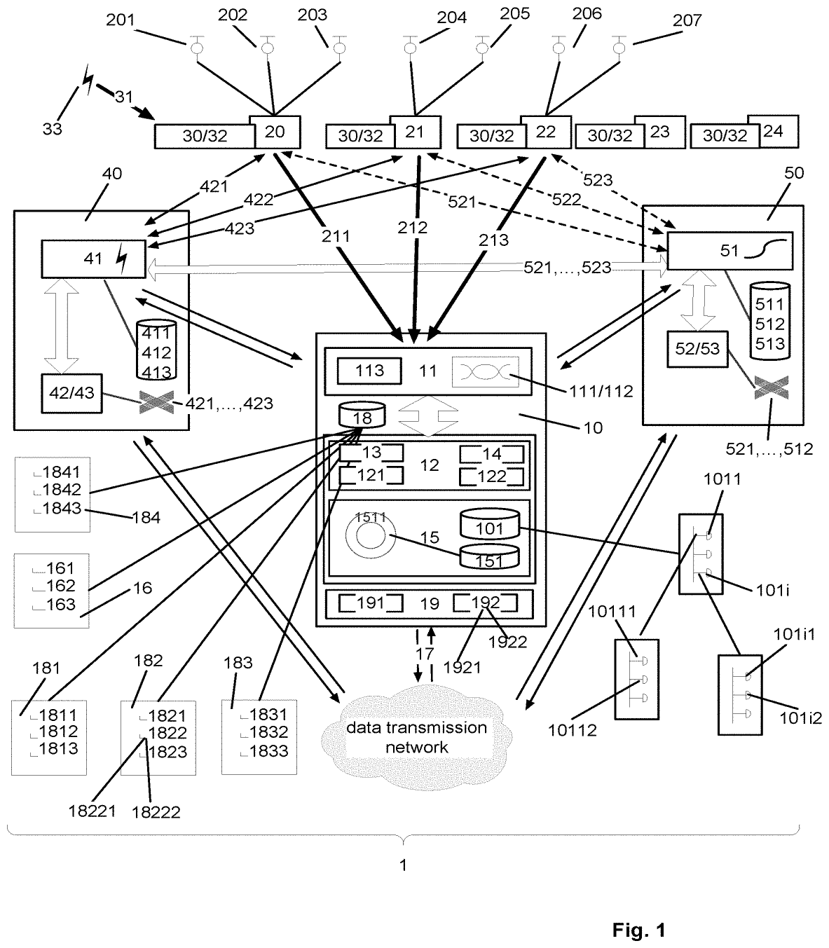

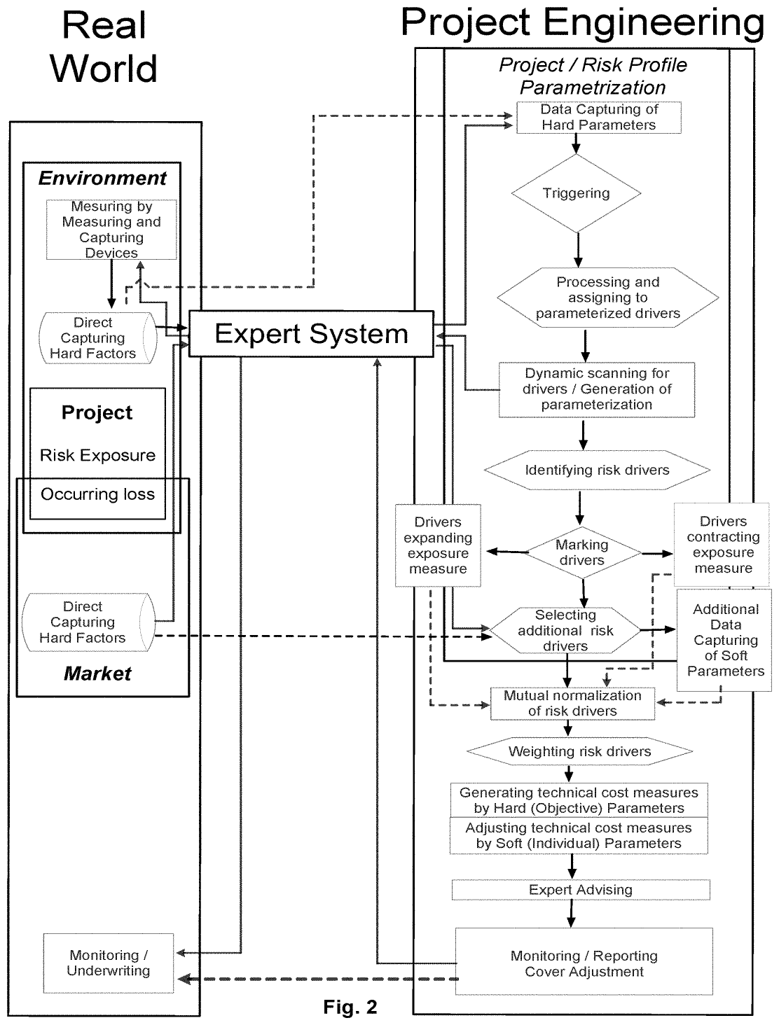

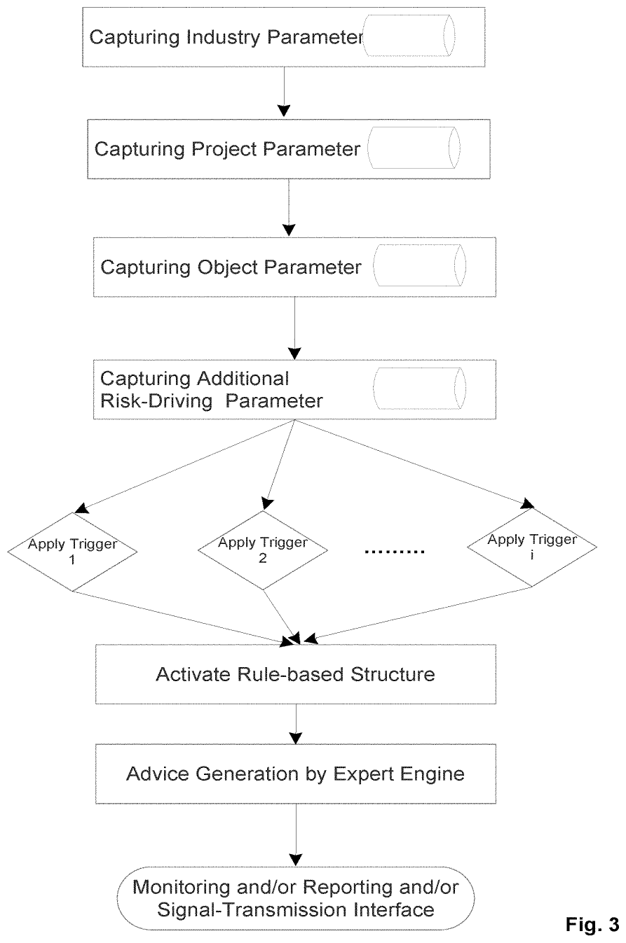

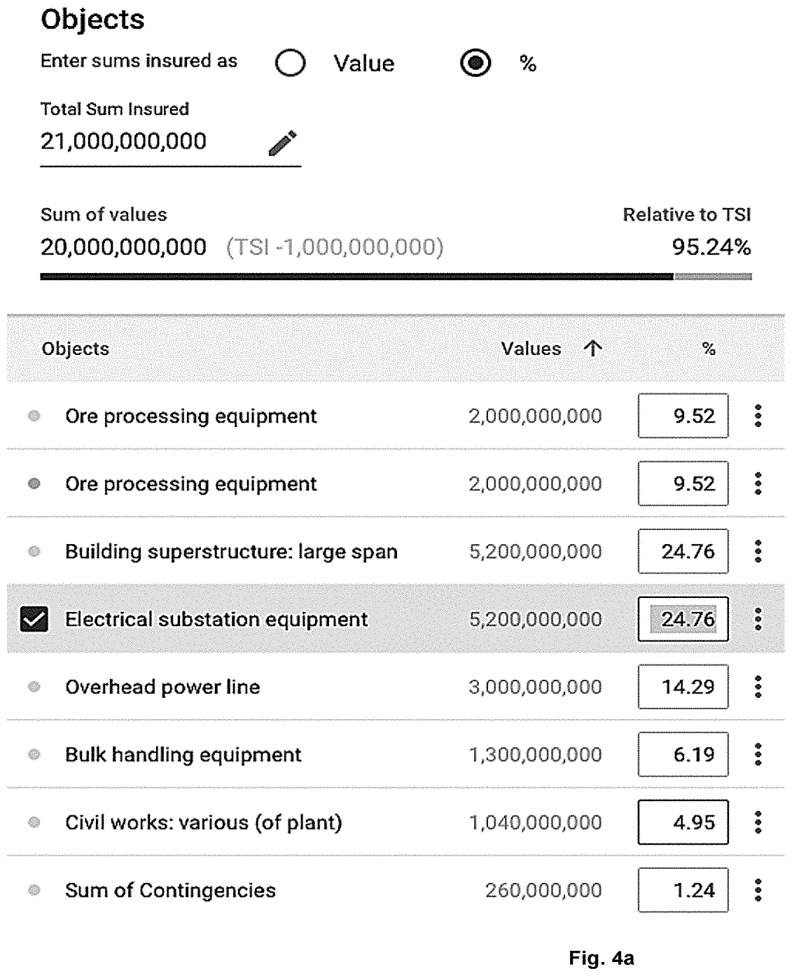

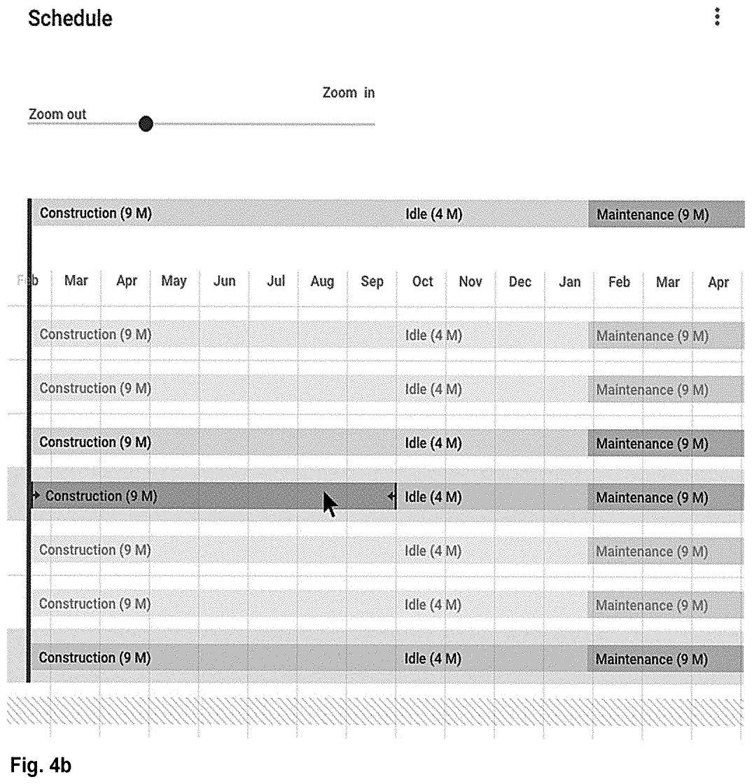

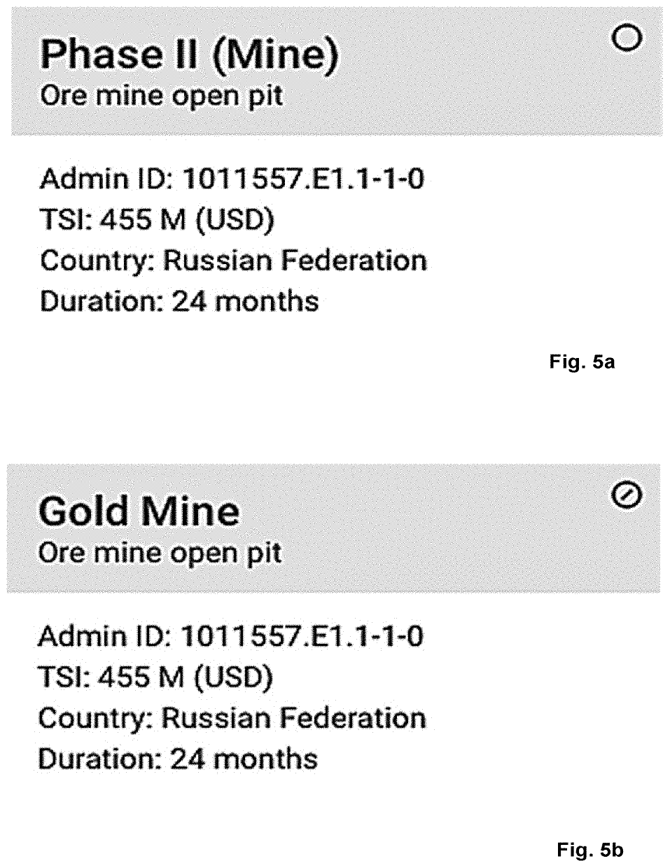

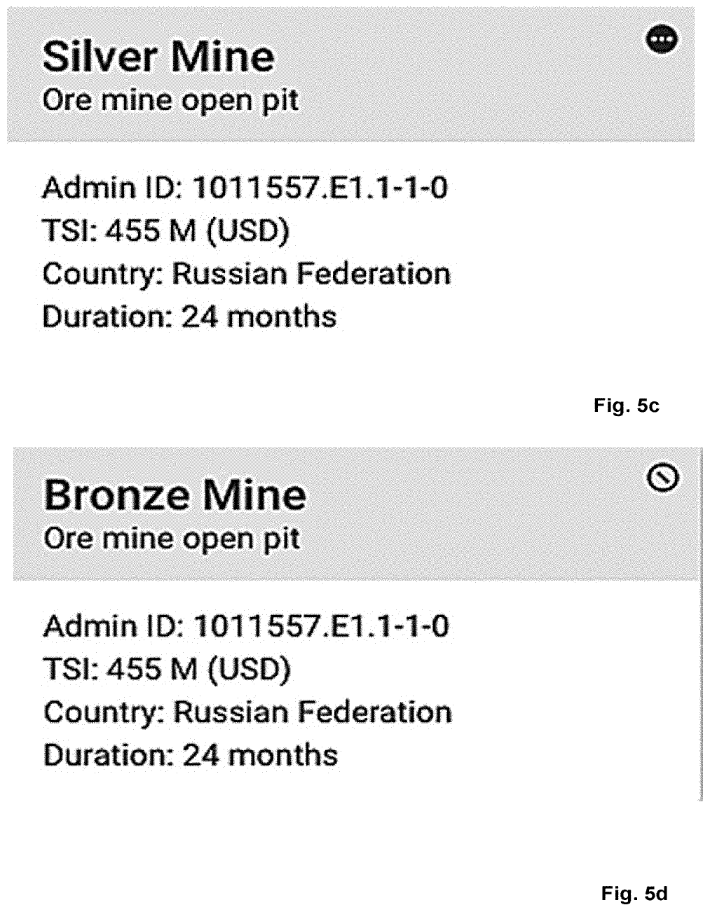

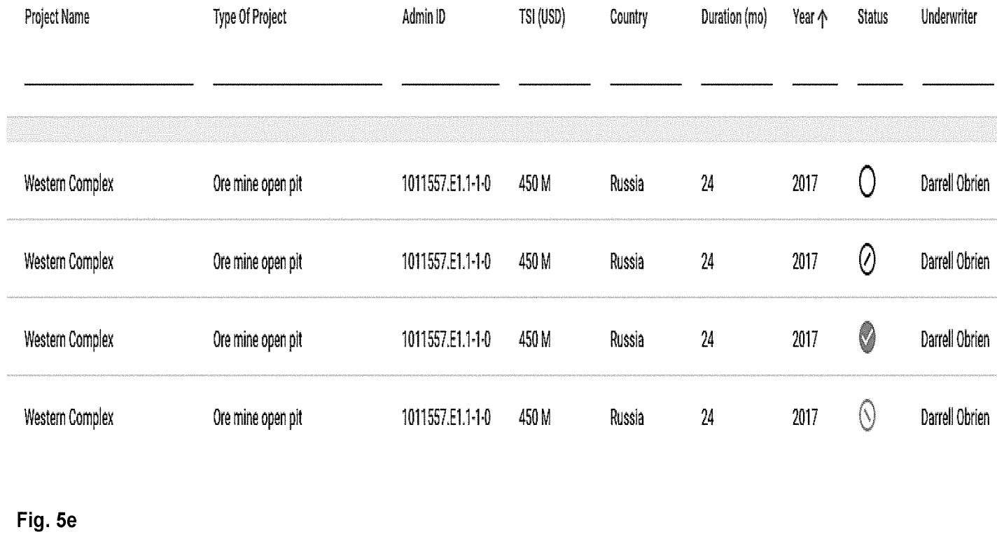

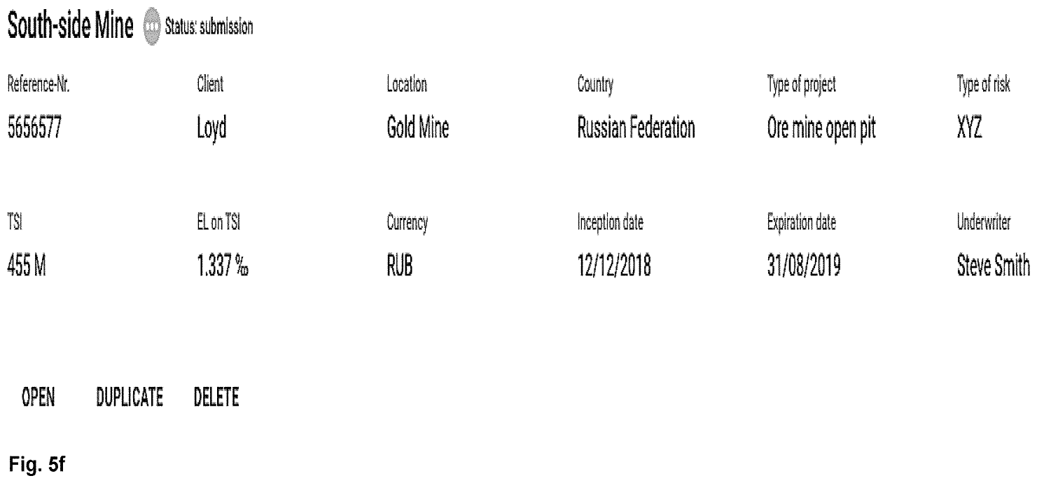

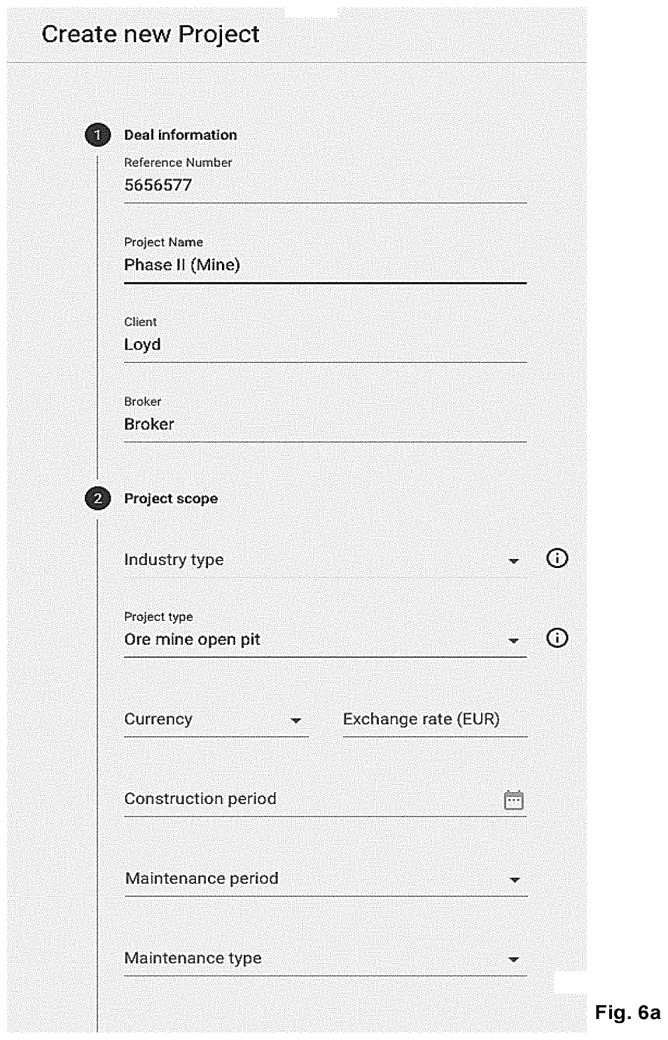

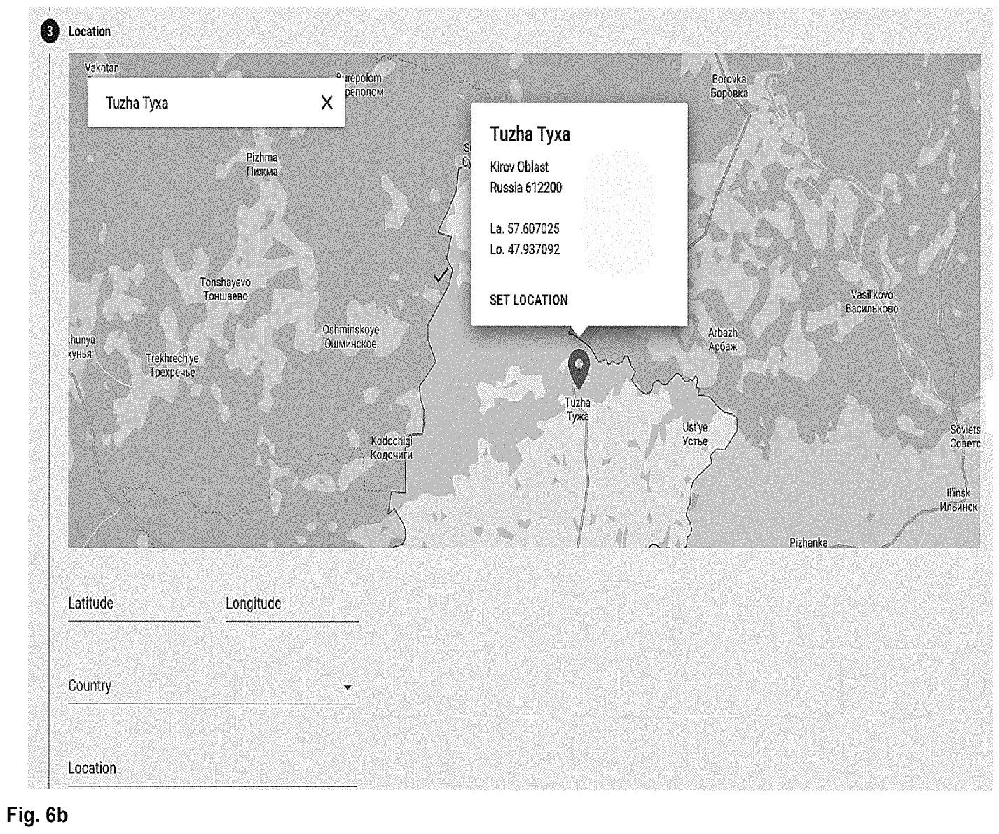

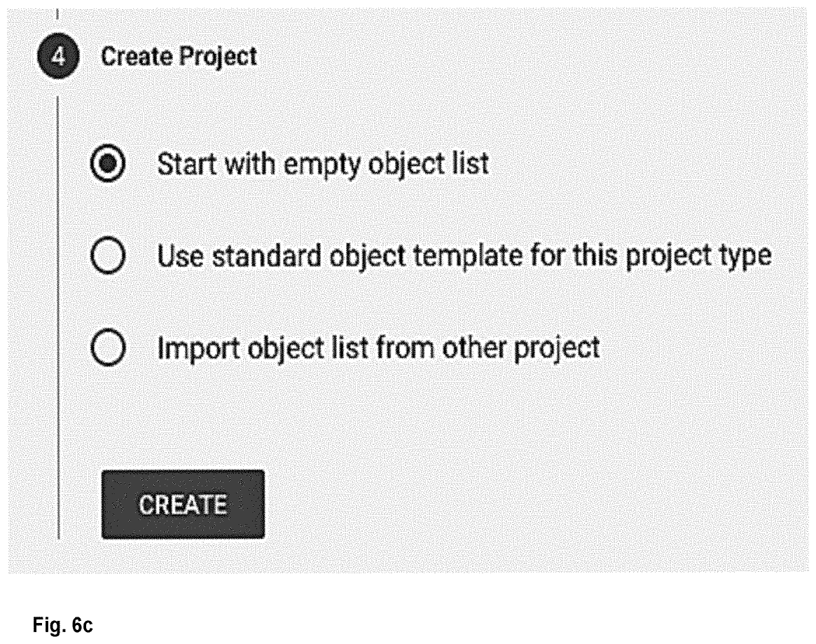

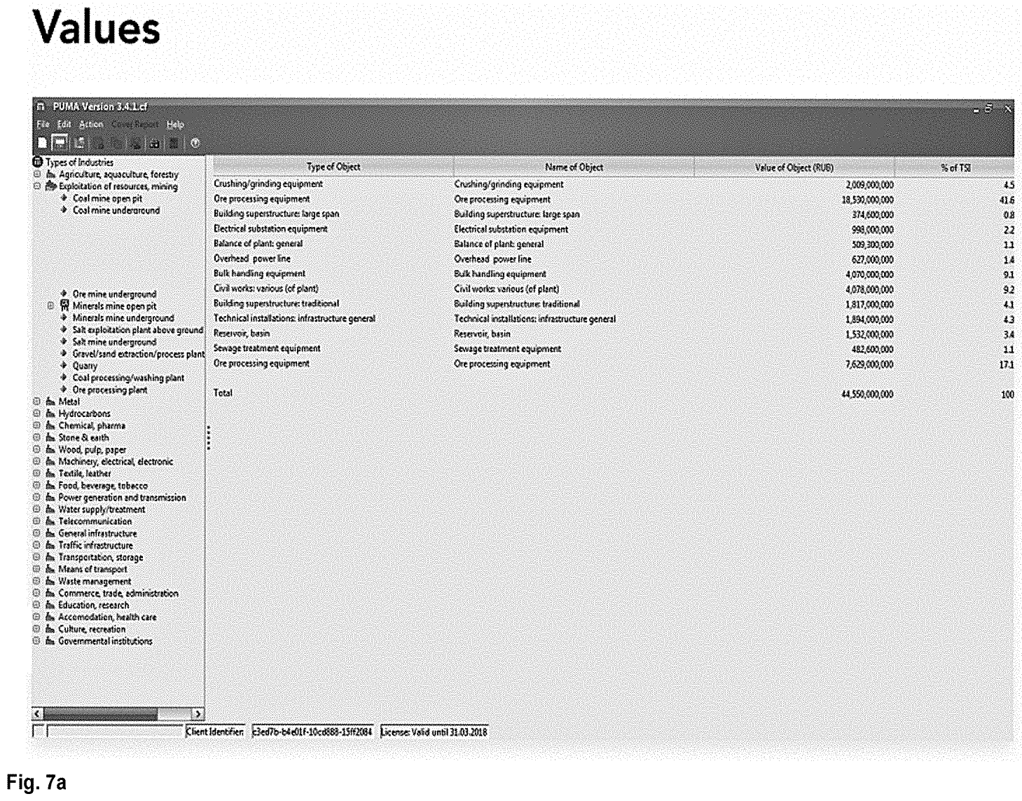

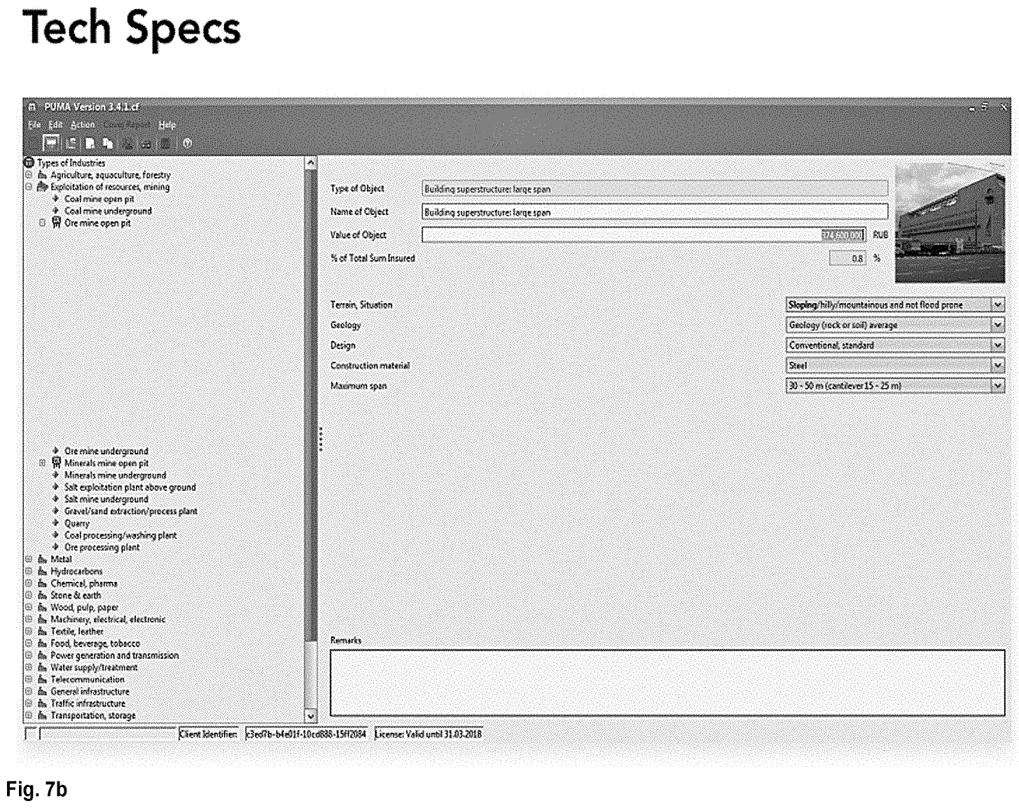

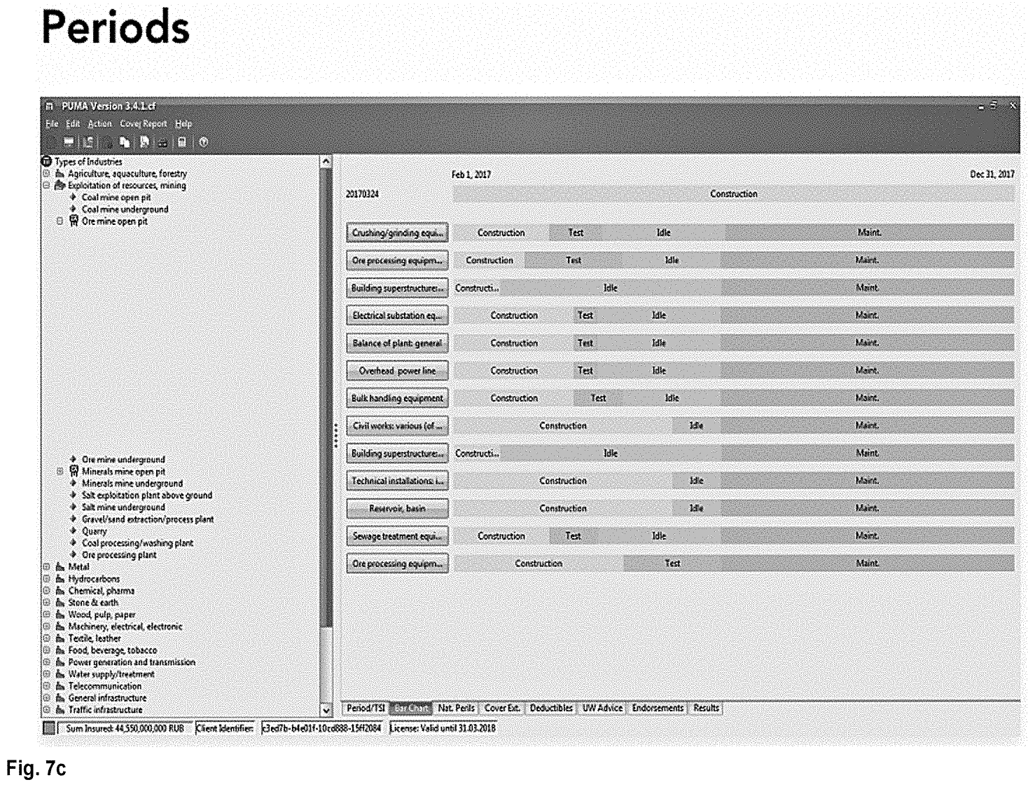

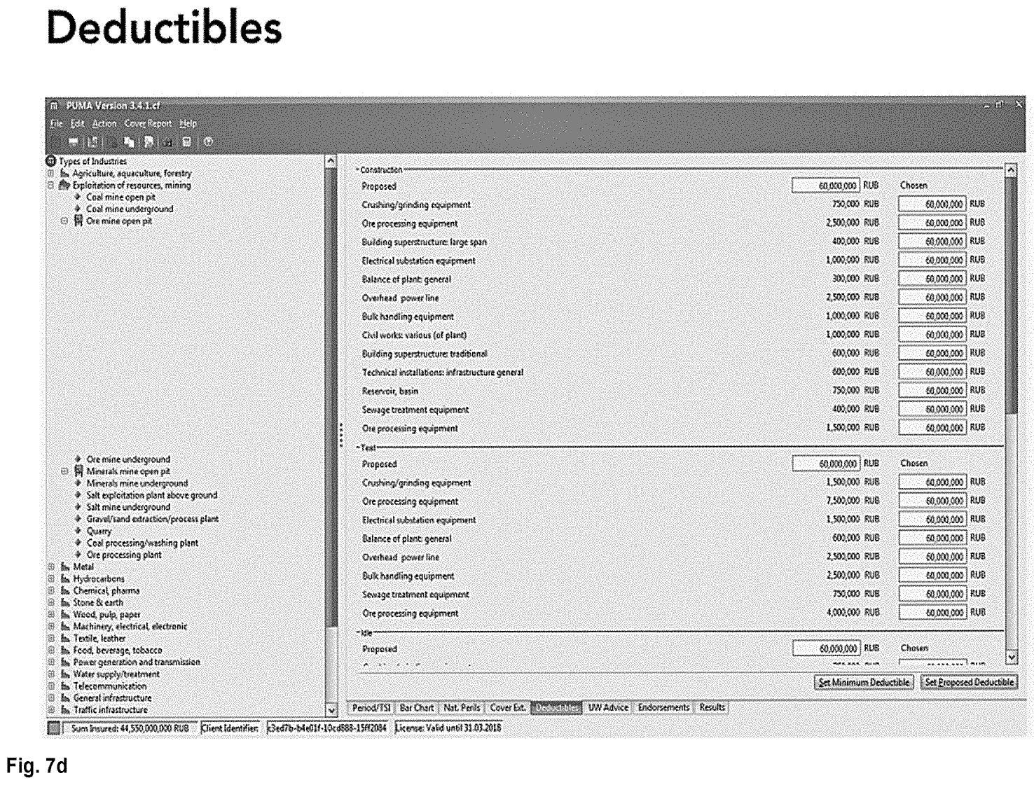

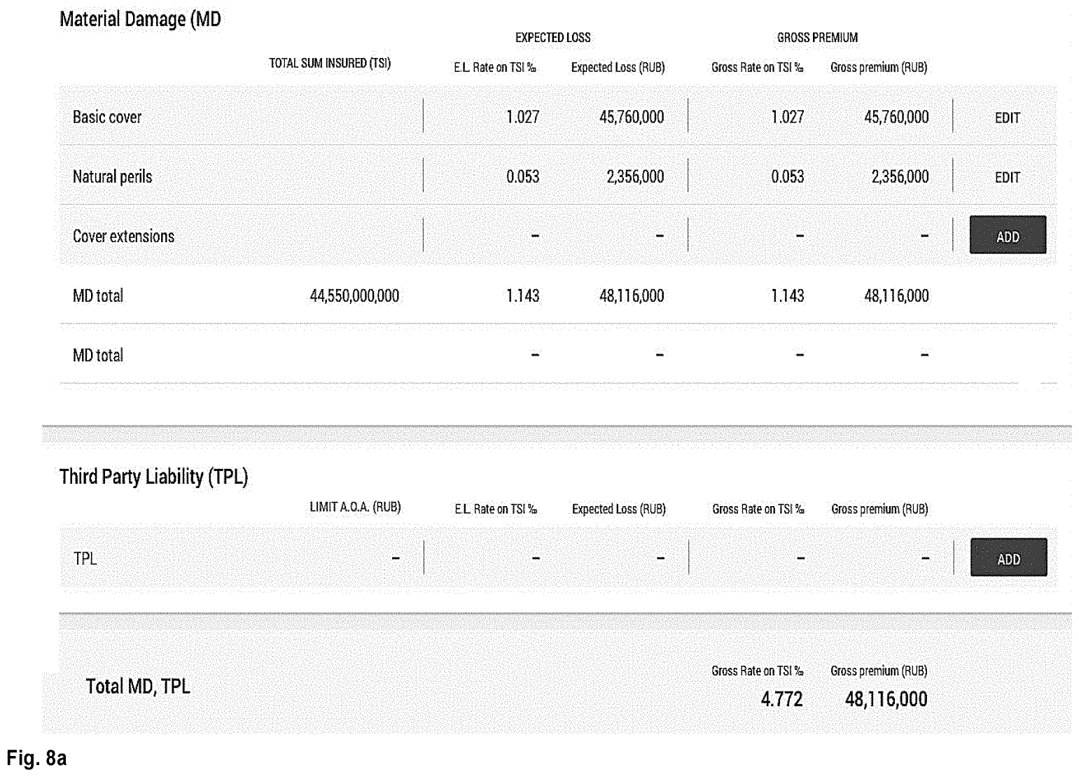

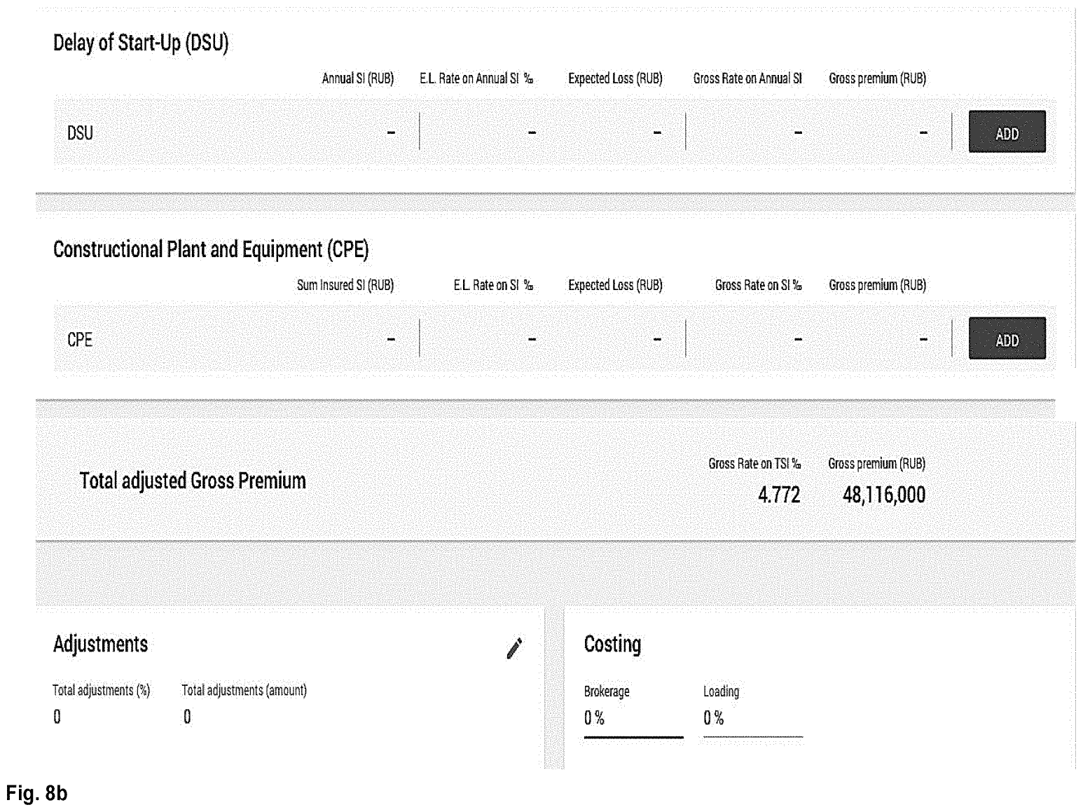

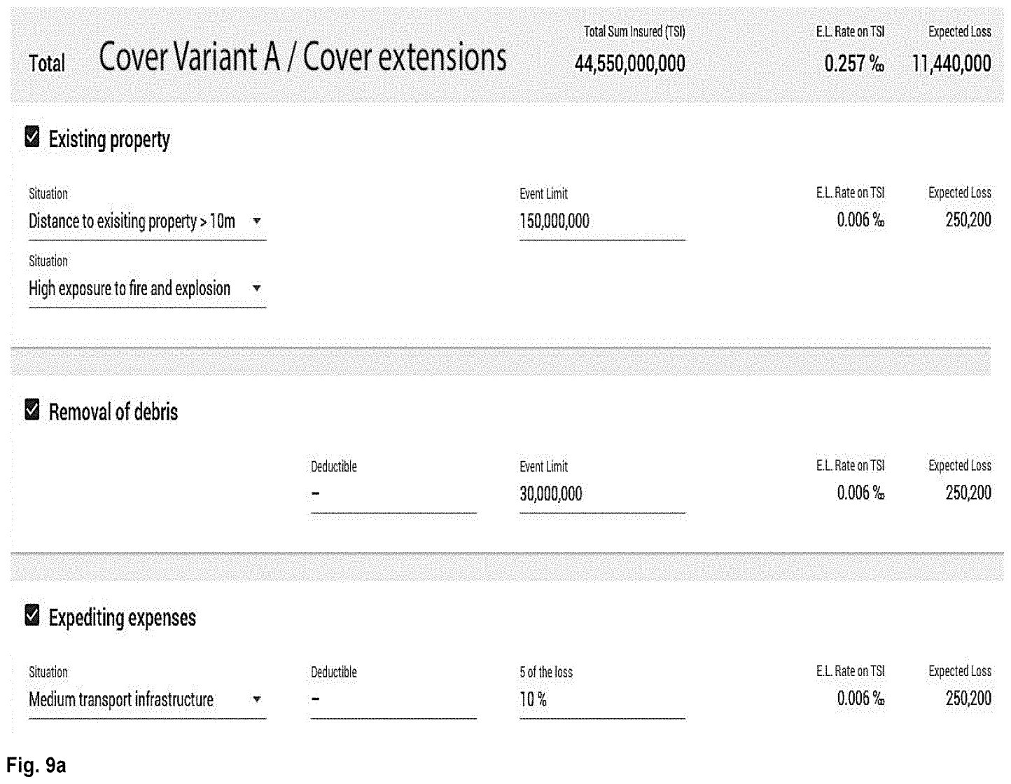

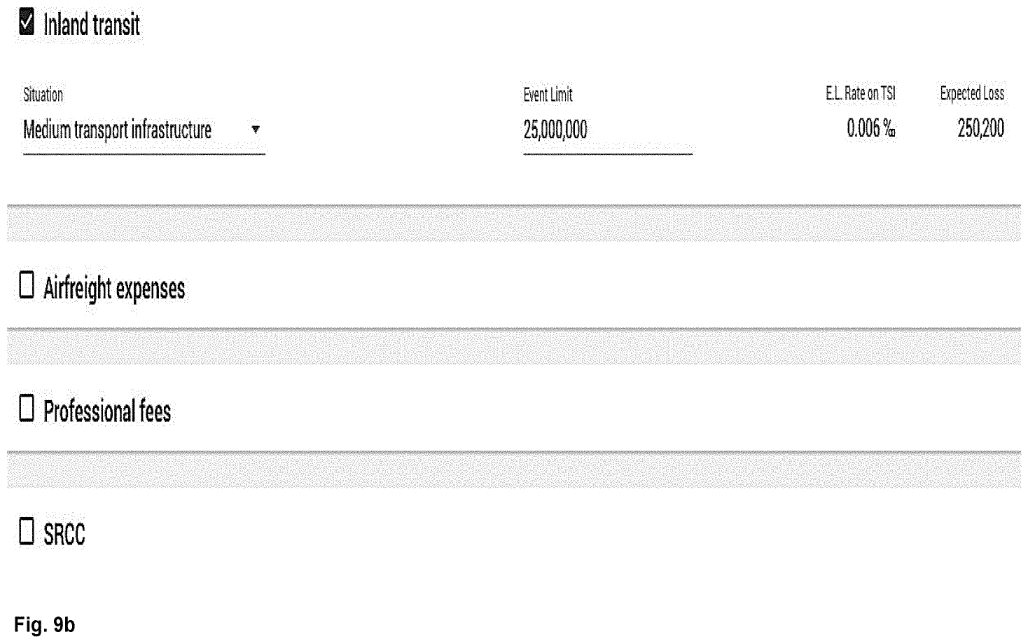

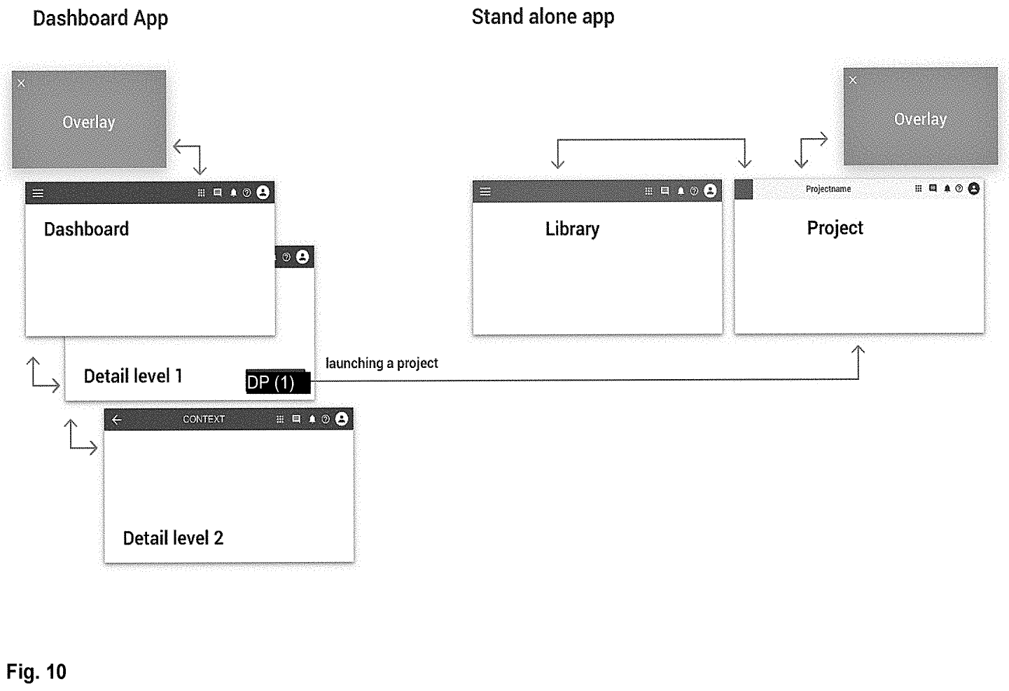

FIG. 1 schematically illustrates an architecture for a possible implementation of an embodiment of the inventive digital platform 1 for automated assessing and rating of construction and erection risks (CAR/EAR), in particular for automated prediction and exposure signaling of associated, construction and/or erection risk-event-driven or -triggered systems; in particular automated first- and second-tier risk-transfer systems 40/50 transferring risks of construction and/or engineering risk events with a complex structure.

As mentioned the invention provides a digital platform 1 for automated prediction and quantified rating of exposure measures associated with occurring construction and erection risks 31 of an engineering or construction project 20-26 and for automated prediction and measuring of future occurring loss patterns 1511, . . . , 151i induced by occurring construction/erection risk events 33 to the project 20-26 exposed to said construction/erection risks 31. An engineering risk profile 101i2 of a project 20-26 associated with and exposed to construction and/or erection risks 31/CAR/EAR is assembled, and based on the predicted and measured future occurring losses patterns 1511, . . . , 151i, risk-tailored expert advices for underwriting parameters are provided.

A predictive system 10 of the digital platform 1 comprises a persistent storage 18 which includes at least a data-structure for capturing technical parameters 181, and user- and market-specific working parameters 182/1821, . . . , 182i. The digital platform 1 can e.g. comprise a user interface for receiving user-defined values for one or more technical or working parameters associated with the project, wherein each project has a risk profile with a project-specific parameter set assigned, wherein for the assigned risk profile each type of project consists of a ratable standard set of types of objects and wherein based on the received user-defined values, relevant types of objects for the project are automatically selected by the system by adding or deleting types of objects from the standard set. Selecting the objects for the project by means of the received user-defined values can e.g. comprise defining the scope of the project to be quoted including a dataset describing the selected project and/or objects and the related technical characteristics as technical parameters. The technical parameters 181 comprise (i) objective risk parameters 1811 for at least capturing geo location parameters 18111 and/or type of industry parameters 18112 and/or type of project parameters 18113 and/or structure of the project parameters 18114 and/or duration parameters 18115 and/or involved values at risk parameters 18116, and further comprise (ii) cover component parameters 1812 at least comprising cover type parameters 18211 and/or deductibles parameters 18212 and/or sublimit parameters 18213.

The persistent storage 18 can e.g. further comprise system-related core data 183/1831, . . . , 183i with at least software application data at least comprising messages, prompts, user preferences, application settings and logging/tracing information. The technical parameters 1811/1812 can e.g. at least comprise data types of industries, data types of projects, data types of objects, a standard subset of types of objects for a type of project, data types of periods, classes of data types of objects, data types of perils of nature, data types of covers of extension, data types of rate tables, data types of tariff algorithms, default parameters, business validation rules, data validation rules, and domains of all data types. The working parameters 182 can e.g. comprise user generatable data restricted to read, write and modify access by the user only. The captured risk-related technical parameter values can e.g. comprise at least a technical characteristic, an insurance related characteristic, a type of project, and a type of object.

A generic framework structure 20 is maintained based on the working parameters 182 for capturing user-specific pricing logics, the working parameters 182 comprising (i) first working parameters 1821 quantifying individual risk measures, and (ii) second working parameters 1822 quantifying user-specific internal and external cost measures 18221/18222. The generic framework structure 12 comprises a first trigger stage 13 identifying and capturing objective cost measures 1841 triggered by the objective risk parameter values 1811 and the cover component parameter values 1821, and a second trigger stage 14 capturing market-specific prize measures 1842 triggered by the first and second working parameter values 1821/1822 providing the user-specific price logic, wherein the generic framework structure 12 comprises (a) an interface 113 assessable by a user for receiving user-defined values for one or more objective or working parameters 1811/1812 relating to the project 1011, . . . , 101i, (b) a weighting module 121 for adjusting the technical cost measures based on the first working parameters quantifying the individual risk measures, and (c) an aggregation module 122 aggregating the technical cost measures with the second working parameters quantifying the user-specific internal and external cost measures 18221/18222.

The digital platform 1 comprises an advice engine 19 generating user-specific expert advices 191 to the user for optimizing the user-specific cover component parameters 1812 by referring to underlying policy wording and clauses. Optimized user-specific cover component parameter values 1812 and corresponding prizing parameter values 1813 are provided associated with the generated user-specific expert advices 191. By means of the user interface 113 of the digital platform 1, the underwriting parameters 192/1921 and associated rates 192/1922, respectively, are dynamically adjustable by a user.

A rating process can e.g. be processed by the digital platform 1, as a result of applying a set of rules, to generate a rating analysis by the expert system, and to output one or more of underwriting hints for the risk-covered project, the rating analysis includes the following: a deductible associated with one or more covered risks, and a premium associated with one or more covered risks. The applying of the set of rules can e.g. comprise: (i) applying one or more triggers to test for values of one or more data items that represent risk-related values by making a true or false determination with respect to a value of the values; (ii) activating a rule based structure on a test result of one or more of the triggers to generate the one or more underwriting hints to be outputted, wherein the underwriting hints are separate from the deductible and the premium and include at least the following: (a) identification of a risk associated with a geographical area for the risk-covered project, (b) hints to minimize exposure for a peril which include at least one hint which recommends requesting construction to resist damage from a particular type of peril, and (c) identification of a risk associated with one or more technical characteristics of the risk-covered project; (iii) providing the rating analysis and the outputted underwriting hints to a monitoring interface; and (iv) applying one or more additional triggers to test for values of data parameters outputted from the rating analysis. The processing of the rating process can e.g. be performed at the object level by requiring a distinct selection of objects from the technical parameters using a defined standard subset of types of objects from the technical parameters associated with each type of project, wherein, if only a type of project is selected by the user, a standard subset of type of objects from the technical parameters are selectable to run the rating process. The processing of the rating process can e.g. further comprise passing values for characteristics that are valid for the entire project and which are entered at the project level to underlying objects at the object level, and directly entering values for technical and risk-transfer related characteristics that are only valid for specific objects at the object level. The optimized user-specific cover component parameter values 1812 and corresponding prizing parameter values 1813 can be generated by means of a rating process, wherein the rating process includes determining premium parameter values and deductible amounts parameter values. Finally, the optimized user-specific cover component parameter values 1812 and corresponding prizing parameter values 1813 can at least comprise parameter values related to an risk-transfer covering of the risk-exposed project 20, . . . , 26. The capturing of the technical parameters 181 can at least comprises parameter values for selecting a type of industry associated with the risk-exposed project 20, . . . , 26. The user-specific expert advices 191 can e.g. comprises parameters values providing underwriting hints, which indicate severity of a risk associated with the project 20, . . . , 26.

The digital platform 1 can e.g. further comprise a monitoring and reporting interface 17 comprising a portfolio management interface 171 for analyzing and monitoring a portfolio of construction/erection risks exposed projects, wherein a plurality of construction/erection risks exposed projects are gathered by means of one portfolio data structure. The monitoring of the portfolio can e.g. comprise extracting key performance indicator measures associated with the portfolio at least comprising monitoring and/or reporting of accumulation parameters and/or costing/pricing parameters and/or country-specific parameters and/or developments indicators and/or rate developments indicators and/or portfolio sanity indicators.

As a further variant, the advice engine 19 can e.g. comprise a machine-based intelligence comprising a machine-learning based structure or a neural-network-based structure generating the user-specific expert advices 191. The machine-based intelligence in a learning mode assesses optimized underlying policy wording and clauses of historical projects 20-26 together with optimized user-specific cover component parameter values 1812 and corresponding prizing parameter values 1813, and in a processing mode, the machine-based intelligence provides the user-specific expert advices 191 to the advice engine 19.

List of reference signs

```
    1 Digital platform
    10 Predictive, risk-driven system
  101 Project data store
  1011, . . . , 101i Project data records to projects 20, . . . , 2i
101i1 Component data records
101i2 Engineering risk profile
  102 Portfolio data store
  1021, . . . , 102i Portfolio data records holding a plurality of project data
records 1011, . . . , 101i
    11 Signaling module
  111 Signal generation and transmission
  112 Request for measure parameter update
  113 User data interface
    12 Generic framework structure
  121 Weighting module
  122 Aggregation module
    13 First trigger stage
    14 Second trigger stage
    15 Prediction engine
  151 Loss pattern data store
  1511, . . . , 151i Loss pattern
    16 Sets of risk drivers
  161 Set of objective risk drivers
    17 Monitoring and reporting interface
  171 Portfolio management interface
    18 Repository units/persistent storage
  181 Dedicated data storages for the technical parameters
  1811 Objective risk parameters
18111 Geo location parameters
18112 Type of industry parameters
18113 Type of project parameters
18114 Structure of the project parameters
18115 Duration parameters
18116 Involved values at risk parameters
  1812 Cover component parameters
18121 Cover type parameters
18122 Deductibles parameters
18123 Sublimit parameters
  1813 Prizing parameters
  182 Dedicated data storages for the working parameters
  1821 First working parameters quantifying individual risk measures
  1822 Second working parameters quantifying user-specific internal and
external cost measures
18221 Internal cost measures
18222 External cost measures
  183 Dedicated data storages for the core parameters
  1831, . . . , 183i Core parameter i
  184 Dedicated data storages for the cost measure parameters
  1841 Objective cost measure parameters
  1842 Market-specific prize measure parameters
    19 Expert advice engine
  191 Advices based on best fit characteristics
  192 Minimum number of liability risk drivers
    20-26 Risk-exposed project
  201, . . . , 206 Measuring devices
  211, . . . , 216 Measure parameters
    30 Risk-exposed components
    31 Risk exposure (real world)
  311-313 Risk drivers
    32 Signal transmission interface
    33 Risk event
    40 Automated risk-transfer system
    41 Signal transmission interface
  411, . . . , 413 Risk transfer parameters
    42 Payment transfer modules
  421, . . . , 423 Payment transfer parameters
    43 Automated first resource pooling system
    50 Automated second risk-transfer system
    51 Signal transmission interface
  511, . . . , 513 Risk transfer parameters
    52 Payment transfer modules
  521, . . . , 523 Payment transfer parameters
    53 Automated second resource pooling system
```

1. A digital platform for automated prediction and quantified measuring of exposure-measures measuring occurring construction and erection risks of an engineering or construction project and for automated forecast and measuring of future occurring loss patterns induced by occurring construction/erection risk events to the project measurably exposed to construction/erection risks, wherein an engineering risk profile of a project associated with and exposed to construction and/or erection risks is assembled, and wherein, based on the predicted and measured future occurring losses patterns, risk-tailored expert advices for underwriting parameters are provided, the digital platform comprising:
a predictive system, implemented by processing circuitry, that comprises a persistent storage that includes at least a data-structure for capturing technical parameters, and user- and market-specific working parameters, wherein the technical parameters comprise (i) objective risk parameters for at least capturing geo location parameters and/or type of industry parameters and/or type of project parameters and/or structure of the project parameters and/or duration parameters and/or involved values at risk parameters, and further comprise (ii) cover component parameters at least comprising cover type parameters and/or deductibles parameters and/or sublimit parameters;
a generic framework structure, implemented by the processing circuitry, that is maintained based on the working parameters for capturing user-specific pricing logics, the working parameters at least comprising (i) first working parameters quantifying individual risk measures, and second working parameters quantifying user-specific internal and external cost measures, the generic framework structure comprising a first trigger stage identifying and capturing objective cost measures triggered by the objective risk parameter values and the cover component parameters, and a second trigger stage capturing market-specific prize measures triggered by the first and second working parameter values providing the user-specific price logic, wherein
the generic framework structure comprises (a) an interface assessable by a user to receive user-defined values for one or more objective or working parameters relating to the project, (b) a weighting module configured to adjust the technical cost measures based on the first working parameters quantifying the individual risk measures, and (c) an aggregation module configured to aggregate the technical cost measures with the second working parameters quantifying the user-specific internal and external cost measures; and
an advice engine, implemented by the processing circuitry, configured to generate user-specific expert advices to a user to optimize the user-specific cover component parameters by referring to underlying policy wording and clauses, wherein optimized user-specific cover component parameter values and corresponding prizing parameter values are provided associated with the generated user-specific expert advices, and wherein the underwriting parameters and associated rates being, respectively, dynamically adjustable by a user via a user interface.

2. The digital platform according to claim 1, further comprising a monitoring and reporting interface that comprises a portfolio management interface to analyze and monitor a portfolio of construction/erection risks exposed projects, wherein a plurality of construction/erection risks exposed projects are gathered by one portfolio data structure.

3. The digital platform according to claim 2, wherein the monitoring of the portfolio comprises extracting key performance indicator measures associated with the portfolio at least comprising monitoring and/or reporting of accumulation parameters and/or costing/pricing parameters and/or country-specific parameters and/or developments indicators and/or rate developments indicators and/or portfolio sanity indicators.

4. The digital platform according to claim 1, further comprising a user interface configured to receive user-defined values for one or more technical or working parameters associated with the project, wherein each project has a risk profile with a project-specific parameter set assigned, wherein for the assigned risk profile each type of project consists of a ratable standard set of types of objects, and wherein based on the received user-defined values, relevant types of objects for the project are automatically selected by the predictive system by adding or deleting types of objects from the standard set.

5. The digital platform according to claim 4, wherein selecting the objects for the project by the received user-defined values comprises defining a scope of the project to be quoted including a dataset describing the selected project and/or objects and related technical characteristics as technical parameters.

6. The digital platform according to claim 5, wherein the processing circuitry is configured to process a rating process, as a result of applying a set of rules, to generate a rating analysis by the expert system, and to output one or more of underwriting hints for the project, the rating analysis including:
a deductible associated with one or more covered risks, and
a premium associated with one or more covered risks.

7. The digital platform according to claim 6, wherein the processing circuitry applies the set of rules by:
(i) applying one or more triggers to test for values of one or more data items that represent risk-related values by making a true or false determination with respect to a value of the values,
(ii) activating a rule based structure on a test result of one or more of the triggers to generate the one or more underwriting hints to be outputted, wherein the underwriting hints are separate from the deductible and the premium and include at least: (a) identification of a risk associated with a geographical area for the project, (b) hints to minimize exposure for a peril which include at least one hint which recommends requesting construction to resist damage from a particular type of peril, and (c) identification of a risk associated with one or more technical characteristics of the project,
(iii) providing the rating analysis and the outputted underwriting hints to a monitoring interface; and
(iv) applying one or more additional triggers to test for values of data parameters outputted from the rating analysis.

8. The digital platform according to claim 6, wherein the processing circuitry processes the rating process at the object level by requiring a distinct selection of objects from the technical parameters using a defined standard subset of types of objects from the technical parameters associated with each type of project, wherein, if only a type of project is selected by the user, a standard subset of type of objects from the technical parameters are selectable to run the rating process.

9. The digital platform according to claim 8, the processing circuitry processes the rating process by passing values for characteristics that are valid for the entire project and which are entered at the project level to underlying objects at the object level, and directly entering values for technical and risk-transfer related characteristics that are only valid for specific objects at the object level.

10. The digital platform according to claim 1, wherein the persistent storage further stores system-related core data with at least software application data at least comprising messages, prompts, user preferences, application settings and logging/tracing information.

11. The digital platform according to claim 1, wherein the technical parameters comprise at least data types of industries, data types of projects, data types of objects, a standard subset of types of objects for a type of project, data types of periods, classes of data types of objects, data types of perils of nature, data types of covers of extension, data types of rate tables, data types of tariff algorithms, default parameters, business validation rules, data validation rules, and domains of all data types.

12. The digital platform according to claim 1, wherein the working parameters comprise user generatable data restricted to read, write, and modify access by the user only.

13. The digital platform according to claim 1, wherein the technical parameter include at least a technical characteristic, an insurance related characteristic, a type of project, and a type of object.

14. The digital platform according to claim 1, wherein the advice engine comprises a machine-based intelligence comprising a machine-learning based structure or a neural-network-based structure generating the user-specific expert advices, wherein the machine-based intelligence in a learning mode assesses optimized underlying policy wording and clauses of historical projects together with optimized user-specific cover component parameter values and corresponding prizing parameter values, and wherein in a processing mode, the machine-based intelligence provides the user-specific expert advices to the advice engine.

15. The digital platform according to claim 1, wherein the optimized user-specific cover component parameter values and the corresponding prizing parameter values are generated by a rating process, wherein the rating process includes determining premium parameter values and deductible amounts parameter values.

16. The digital platform according to claim 1, wherein the optimized user-specific cover component parameter values and the corresponding prizing parameter values comprise at least parameter values related to a risk-transfer covering of the project.

17. The digital platform according to claim 1, wherein the capturing of the technical parameters comprises at least parameter values for selecting a type of industry associated with the project.

18. The digital platform according to claim 1, wherein the user-specific expert advices comprise parameters values providing underwriting hints, which indicate severity of a risk associated with the project.
